(19) United States
(12) Patent Application Publication
(10) Pub. No.: US 2024/0117854 A1
(43) Pub. Date: Apr. 11, 2024

(54) VIBRATION DAMPING DEVICE

(71) Applicant: Peerapol CHOTIPAN, Bangkok (TH)

(72) Inventor: Peerapol CHOTIPAN, Bangkok (TH)

(21) Appl. No.: 18/548,227

(22) PCT Filed: Jun. 14, 2021
(86) PCT No.: PCT/TH2021/000033

§ 371 Date: Aug. 29, 2023

(30) Foreign Application Priority Data
Mar. 22, 2021 (TH) TH2101003428

(51) Int. Cl. F16F 15/02

(52) U.S. Cl. CPC F16F 15/021; F16F 2230/14

(57) ABSTRACT

An invention that reduces the vibration of objects or systems by using the contact stress of three ball bearings stacked at each layer, at least two layers, within the cylindrical surface of the housing. There is a retainer at the top of the layer for pressing all the ball bearings and there is a gap between the retainer and the housing so that they do not touch each other. The retainer have mounting plane of which the angles can adjust to be in line with the mounting plane of the housing. When placing at least three inventions among objects or systems that one wishes to reduce the vibration by placing the mounting plane of the housing directly in contact with such objects or system, the invention will be completely motionless, keep the contact stress constant and at its maximum level and increase the vibration's damping ration of the inventions.

### TECHNICAL FIELD

Mechanical engineering: Mechanical vibration, vibration of systems with dampers, Newton's laws, Hertz's contact stress theory.

### BACKGROUND ART

The vibration affects various appliances especially audio electrical appliances. The effects will reduce the quality of the sound we hear. Vibration comes from two parts; vibration from components inside out of an electrical appliance such as power transformers, motors, capacitors, vacuum tubes, speakers, etc.; and vibrations from the external environment of electrical appliances, such as sound waves from speakers that are reflected in a room. As a result, the material of the components of the appliance and all other objects in the room will vibrate. The vibration produces resonance with the natural frequency of all parts of the room. This results in sound from the speakers in the frequency range from 20 to 20,000 Hz contains the object's resonance frequency, causing disturbing noise in the normal sound wave. Therefore, it is necessary to minimize the vibration as much as possible.

According to the principle of system vibration with a vibration damper, when increasing the system vibration higher than the natural frequency, the magnitude of the vibration is reduced as the damping ratio of the system increases.

There are many devices that were invented to reduce or eliminate unwanted vibrations by applying the Hertz's contact theory to increase the damping-to-vibration ration, for example, according to U.S. Pat. No. 6,655,668B1, as updated in U.S. Ser. No. 10/801,577B2, for example.

As shown in FIG. 1, each class of ball bearing has the same number as appropriate. There may be as few as 3 ball bearings in the first and second layer (not shown). The first layer contains 5 ball bearings and the second contains 5 ball bearings. The bearing retainer consists of a conical part that is directly in contact with all five ball bearings at the first layer at approximately 45 degree angle. This retainer will transfer the compression force to the ball bearing. The central axis of the retainer is threaded through the hole in the middle of the housing section where the ball bearing are loaded, the nut is tightened with the housing tightly and loosely in some way

However, there is a problem with the contact points of all 5 ball bearings and the straight surface cone of the bearing retainer. Not every ball has the contact point due to the tolerance of the ball's size. In fact, everything that is produced will always have a size tolerance.

Although tightening the nut to secure the bearing retainer to the housing might create a lot of pressure on the ball bearings, there is a problem with the vibration connection from the retainer to the housing. If the nut is tightened loosely to the housing, the problem of connecting the vibration from the retainer to the housing can be solved.

It was found that the bearing retainer with straight surface conical shape will cause poor transfer of the vertical pressure and difficult to move freely along the pressed plane when the pressure plane is not parallel to the surface plane outside the retainer.

Also, it was found the problem of tightening the nut loosely with this type of housing to allow the retainer to move freely but it can only be done a little because the pivot point of the bearing and retainer plane of contact is much higher than the point where the threaded rod passes through the housing. Therefore, even if the plane of the contact point deviates slightly, it will cause a large deviation of the thread axis where the thread passes through the housing causing the bearing retainer and the housing to come into contact. It was possible to connect the vibration from the retainer to the housing. Making a lot of space around the threaded rod is limited if the number of ball bearings in each layer is less than 5 balls, there will be no gap to allow the screw rods to pass through the holes of this housing.

Some forms (FIG. 3, FIG. 5, FIG. 6 and FIG. 7) of this patent are almost the same as the previous one but there is a difference. The bearing retainer has a grooved surface with a curved radius. The point of contact with the ball bearing is at the top. This type of retainer is good as releasing the top pressure. But there is almost no horizontal pressure. This makes the retainer vibrate when there is a force acting on it horizontally.

Some forms (FIG. 8A, FIG. 8B, and FIG. 9) of this patent. The central axis cannot be threaded through the housing. The retainer can only be placed with a weight press so that the bearing easily leaves the housing. The retainer has a grooved surface with a curved radius. The point of contact with the ball bearing is at the top. This makes the retainer vibrate when there is a force acting on it horizontally.

Many devices have various problems. If the ball bearing has 3 balls per layer, it will have the most stability of the system. But there will be no space for a thread to attach to the axis of the retainer. And the straight conical contact surface of the retainer will press the bearing unbalanced and unstable. Because the horizontal and vertical force transfer is not good. As a result, the device's performance is not as good as it should be.

### SUMMARY OF THE INVENTION

The invention is a vibration damping device. It consists of three components. The first component is the housing. The second component is a set of three ball bearing that are stacked at each layer inside the housing. And the third component is the retainer, which acts as the bearing press. It is intended to solve the problem of contact between the bearings placed inside the housing and the retainer of the device by keeping all the contact points of the damping system in the most equilibrium and stable state.

The characteristics and purpose of the invention are as follows.

Using the principle of stacking of three ball bearing in a housing with a flat base and a cylindrical wall, the cylindrical wall can contain only three ball bearing per layer. All ball bearing are aligned with natural gravity. The bottom bearing touches the flat base and the cylindrical wall portion of the housing. The bearings of the other layers touch the lower bearing and the cylindrical wall of the housing.

Three ball bearings of each layer have a space between them allowing all bearings to be able to move along the surface of the flat base and the cylindrical wall according to the plane deviation of the pressure at the top three ball bearings. And the bearing retainer is always in contact with the top three bearings, unaffected by the ball bearing size tolerance. All bearings will stand still in equilibrium state from action and reaction force. Although there is only a slight pressure from the system or device that needs to reduce the vibration damping ratio to a very high level and this invention of vibration dampers will be of the highest quality and all the same. Separating the damping parts into two parts; firstly, the part of a housing which contains several ball bearings, is the damping part of a system or device that vibrate heavily; secondly, the part of a retainer which acts as the damping part of the system or device that vibrates less. These two damping parts should be made of high natural frequency materials.

Due to the three ball bearings of each layer there is a gap between them. And all the bearings can move along the surface of the base portion and the cylindrical wall portion according to the plane pressure deviation of the top three bearings. This allows the contact plane of the mounting part to be adjusted according to the usage environment. By isolating the damping parts of the retainer and the housing so that they do not touch each other to support the load and maximize the damping ration. The retainer has a curved cone surface and has three diagonal contact points with the three-ball bearing of the top layer. As a result, all objects or systems are in equilibrium and stable.

These and other embodiments which characterize the invention are pointed out with particularly in the claims annexed hereto and forming a part hereof. However, for a better understanding of the invention, its advantages and objectives obtained by its use, reference should be made to the drawings which form an additional part hereof and the accompanying description in which there is illustrated and described embodiments of the invention.

### BRIEF DESCRIPTION OF DRAWINGS

Embodiments of the invention will be described for the purpose of illustration only with reference to the accompanying drawings, as follow:

FIG. 1 shows a three dimension view of the housing of the invention.

FIG. 2 shows a three-dimensional images of a set of three ball bearings stacked in layer for two layers of the invention.

FIG. 3 shows a three-dimensional image of a set of three ball bearings stacked in layer for three layers of the invention.

FIG. 4 shows a three dimension view of the retainer of the invention

FIG. 5 shows a top view of the positions of the ball bearing in a housing of the invention.

FIG. 6 shows a three-dimensional image of a sectional view of the position of the ball bearing in the housing of the invention.

FIG. 7 shows a three-dimensional image of sectional view of the position of the ball bearing in the housing of the invention.

FIG. 8 shows a top view of the arrangement of the ball bearing in a housing of the invention.

FIG. 9 shows a cross-sectional view of the overall components of the invention.

FIG. 10 shows a frontal view of an example of using the vibration damping devices according to the invention.

### DESCRIPTION OF THE INVENTION

The description of this invention will be done by giving an example of the invention and referring to it by using drawings as an example and to help describe it more clearly. And the same parts in the drawings are represented by the reference numbers. And the scope of the invention follows the attached clause.

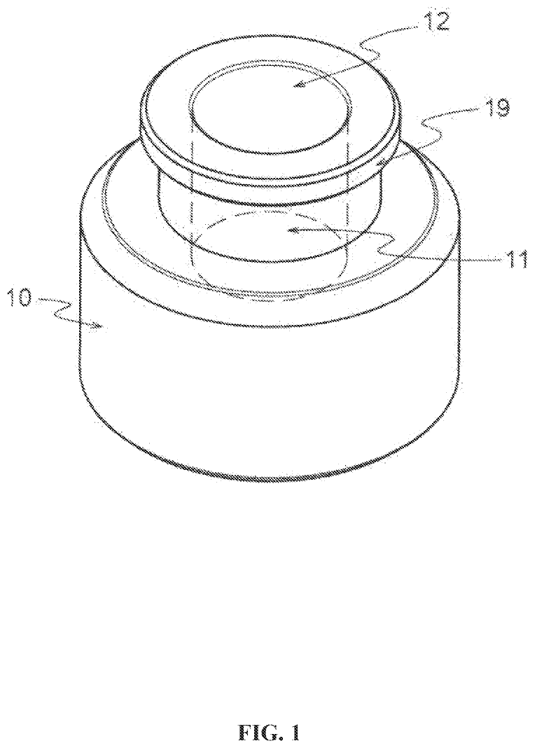

As shown in FIG. 1, a three-dimensional image of a housing 10, which is first component of the vibration damping device according to the invention. The housing 10 has two unique portions. The first portion is a cylindrical surface inside the housing 10 which consists of two subsections. The first subsection is a cylindrical wall 12. The second subsection is a flat base 11, which is connected to the cylindrical wall 12. The radius of the cylindrical wall 12 is determined to contain three ball bearing to be in contact with flat base 11. The second portion is a male lock 19 located on the top edge of the outer wall of the housing 10.

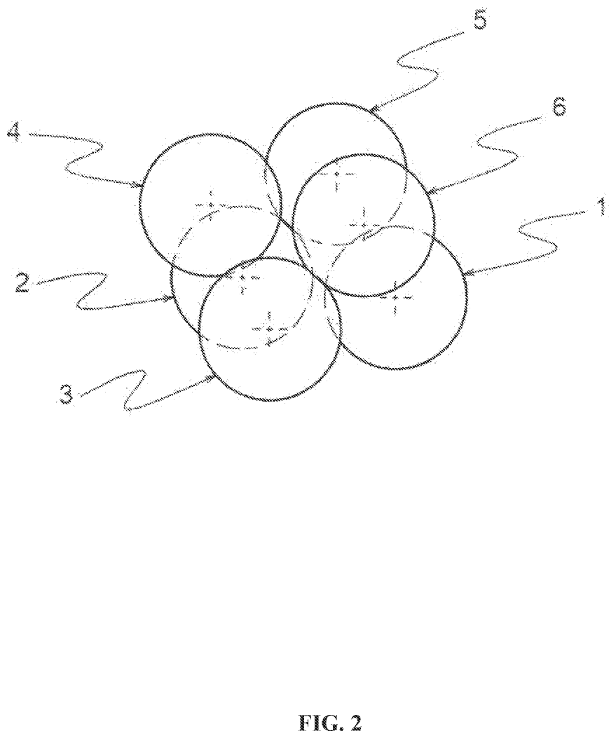

As shown in FIG. 2, a three-dimensional image of a set of three ball bearings per layer being stacked from layers which is the characteristic of the second component of the vibration damping device according to the invention. The set of the ball bearing comprises of three ball bearing 1,2,3 in the first layer and three bearing 4,5,6 in the second layer. The set of ball bearing is stacked crossed by gravity inside the housing 10. All ball bearings are solid spherical and are of the same size or slightly different.

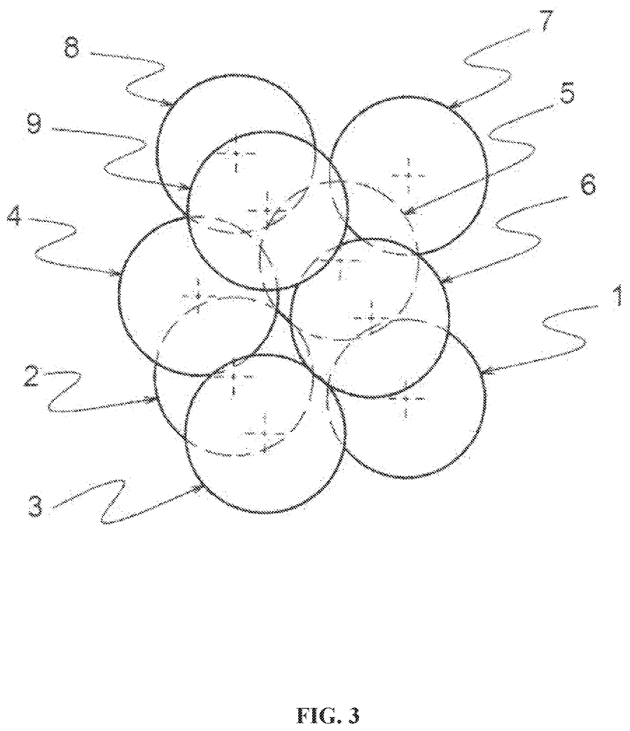

As shown in FIG. 3, a three-dimensional image of a set of three ball bearing per layer being stacked for three layers which is the characteristic of the second component of another embodiment of the invention. The set of ball bearing comprises of three ball bearing 1,2,3 of the first layer, three bearing 4,5,6 in the second layer and three ball bearing 7,8,9 in the third layer. The set of the ball bearings is stacked crossed by gravity inside the housing 10. All bearing are solid spherical and of are the same size or slightly different.

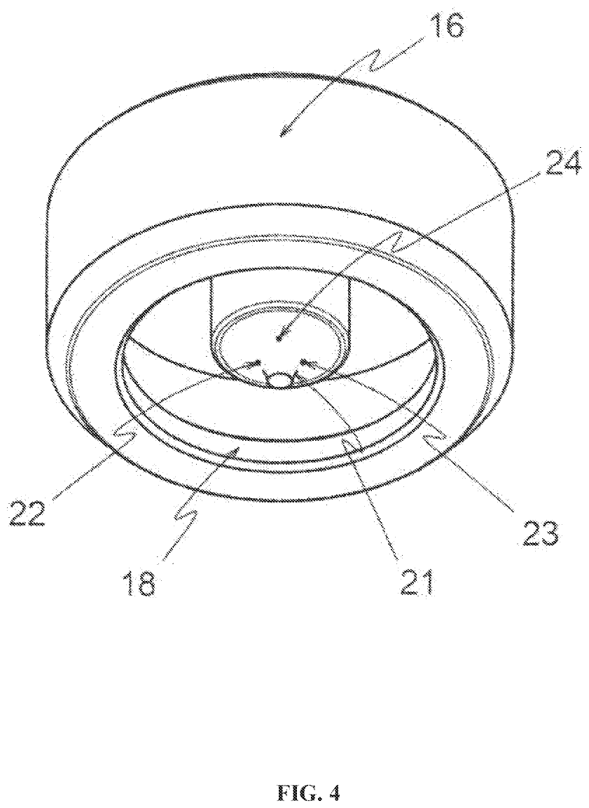

As shown in FIG. 4, a three-dimensional image of a retainer 16, which is the third component of the vibration damping device according to the invention. The retainer 16 is used to press the ball bearing and prevent them from falling off. The retainer 16 has two unique portions. The first portion is a curved cone portion 21 located on the axis inside the retainer 16 to press the top bearings at three contact points 22,23,24. The second portion is a female lock 18 to rotate through or compress through a male lock 19 of the housing 10.

The material of all three components must comply with Hertz's contact theory which are material with the same mechanical properties in all directions, known as isotropic materials such as glass, metal, and plastic, and materials with a high natural frequency as prerequisites, and other conditions taken into consideration.

The housing 10 and the retainer 16 are parts that must be designed and manufactured accordingly. If required, it must be a material with a high natural frequency and can be easily and quickly produced. Metal materials are suitable for such as stainless steel, nickel, titanium, molybdenum, silver, etc., but if the price condition of the material is decided, them stainless steel is the most suitable as the hardness, toughness, and the natural frequency of the object is high. It can be produced with an automatic lathe which is fast and precise, however other material can be used.

Ball bearings are parts that are sold by many manufacturers. There are different types of material such as stainless steel, silicon nitride, zirconium, aluminium oxide, etc. Each has different mechanical properties. Choose one or more types together.

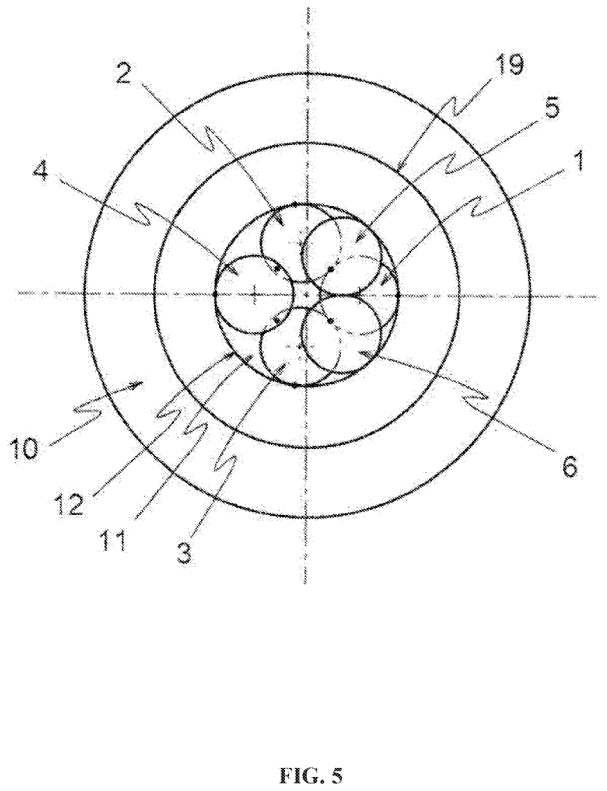

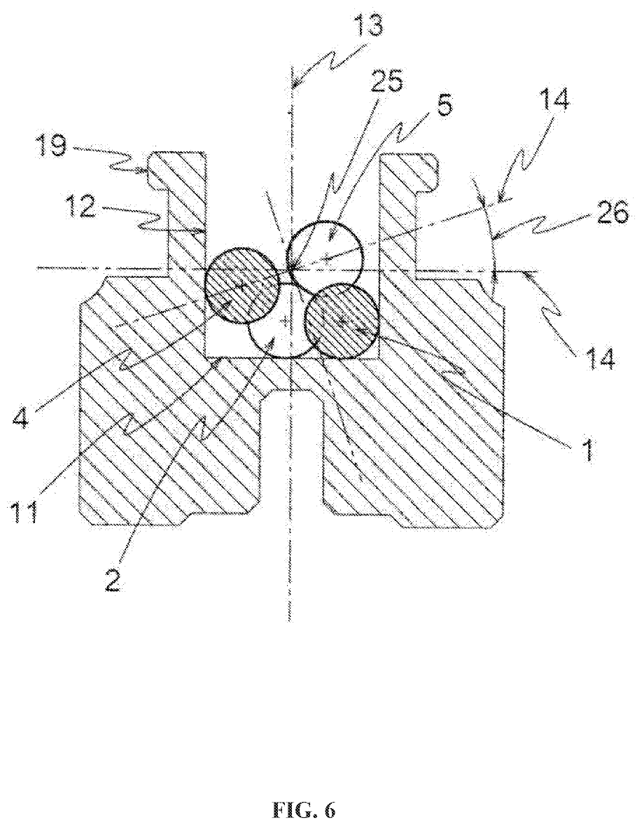

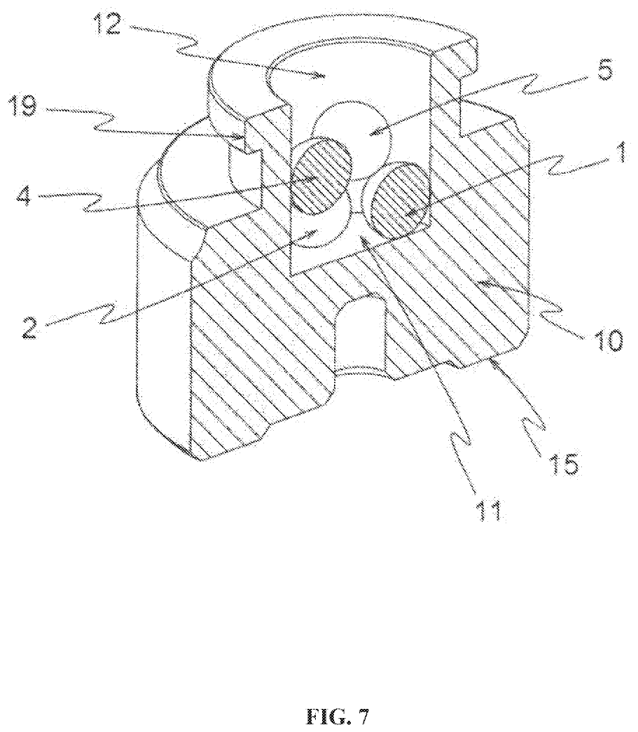

FIG. 5 shows the top view, FIG. 6 shows the cross-sectional view, and FIG. 7 shows a three-dimensional image of the sectional view of the ball bearing positions in the housing 10 of the vibration damping device according to the invention. Show how the ball bearing are arranged inside the housing 10.

The arrangement of the ball bearings in the first layer by placing three ball bearings 1,2,3 inside the housing 10. Determine the radius of the cylindrical wall 12 so that these three ball bearings 1,2,3 are in contact with the flat base 11 with the required or maximum clearance between each ball bearing. Under the conditions, the fourth bearing 4 must not come into contact with the flat base 11.

The arrangement of the ball bearings inside the housing 10 of the second layer, Place the fourth bearing 4 down between the second ball bearing 2 and the third ball bearing 3 of the first layer. The fourth ball bearing 4 will cause both the first layer bearings to touch the cylindrical wall 12 and the first bearing 1. The fourth ball bearing 4 is in contact between the second bearing 2 and the third bearing 3 and floats above the flat base 11.

The fifth ball bearing 5 is placed inside the housing 10. The fifth ball bearing 5 touches and is in the middle of the two bearing 1,2 of the first layer by gravity. The fifth ball bearing 5 receives the reaction force from two bearings 1,2 of the first layer, the direction of the force is directed up to the center of the fifth ball bearing 5 and pushes the fifth ball bearing 5 to touch the cylindrical wall 12.

The sixth ball bearing 6 is placed inside the housing 10. The sixth ball bearing 6 will touch and be in the middle of the two balls 1,3 of the first layer by gravity. The sixth bearing 6 receives the reaction force from the two bearings 1,3 of the first layer. The direction of the force is directed upwards towards the center of the sixth ball bearing 6 and pushes the sixth ball bearing 6 to touch the cylindrical wall 12. If the fourth ball bearing 4 is pressed to the lowest level, according to FIG. 6. The center plane 14 of the second layer bearings 4,5,6 intersects with the housing axis 13, resulting in an angle of inclination 26 with a horizontal plane of approximately 18 degrees at the maximum.

The arrangement of the ball bearings inside the housing 10 of the third layer. (Shown in FIG. 3) The third layer ball bearings 7,8,9 are located between the second layer bearings 4,5,6 by gravity when looking from above to see all the bearing position. The seventh ball bearing 7 will correspond to the first ball bearing 1, the eight ball bearing 8 will correspond to the second ball bearing 2, and the ninth ball bearing 9 will correspond to the third ball bearing 3.

The third layer bearings 7,8,9 are affected by the reaction force of the second layer bearings 4,5,6. The direction of the force is directed upwards towards the third layer bearings 7,8,9 and pushes the bearings of the third layer bearings 7,8,9 come into contact with the cylindrical wall 12.

Adding multiple layers of three bearings, the three bearings positions on each floor are crossed alternately. The ball bearings of odd-numbered layers are in exactly the same position. And the bearings of even-numbered layers are in exactly the same position when viewed from above. If pressed on top of one of the top bearings, all other ball bearings move and touch the internal surface of the housing 10. Adding more layers requires more pressure on the top ball bearings to make all ball bearings to move and touch the internal surface of the housing 10.

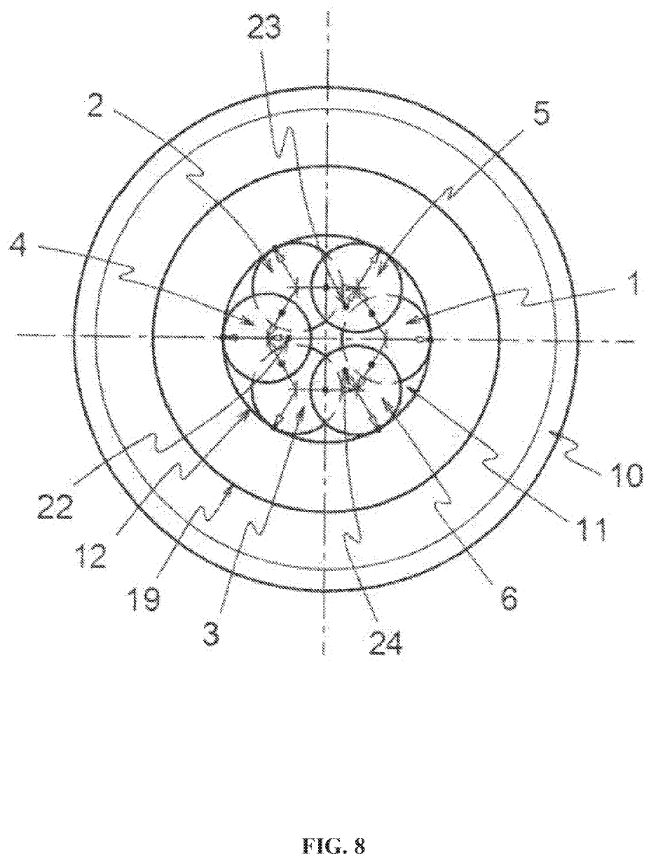

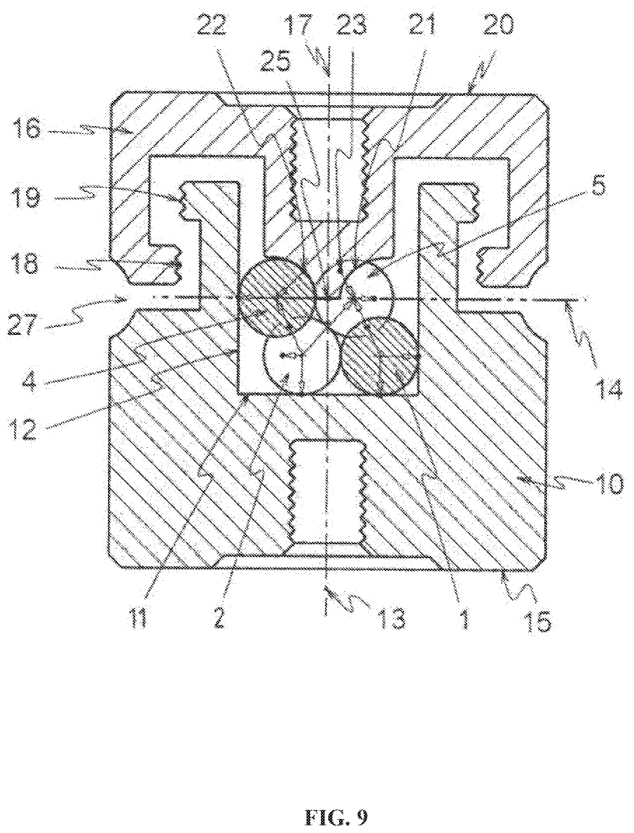

As shown in FIG. 8, a top view of bearings arrangement in the housing 10 of the vibration damping device according to the invention. The first layer ball bearings 1,2,3 have gaps between them. The first layer ball bearings 1,2,3 are in contact with the flat base 11 and the cylindrical wall 12. The second layer ball bearings 4,5,6 are overlaid between the first layer ball bearings 1,2,3 and are in contact with the cylindrical wall 12. There are three points of contact 22,23,24 between the retainer 16 (shown in FIG. 9) and the second layer ball bearings 4,5,6 which receive and transfer force to the center of the second layer ball bearings 4,5,6, keeping all the ball bearings 1,2,3,4,5,6 in equilibrium.

As shown in FIG. 9, the cross-sectional view of the overall components of the embodiment of the invention. When the retainer 16 is closed to the housing 10 and let the a female lock 18 to rotates through or compresses through the male lock 19 by making both locks 18,19 into a thread to rotate through, or by making both lock's edge 18,19 into same size to compress through. The both locks 18,19 will prevent the retainer 16 from falling out of the housing 10. All surface of the retainer 16 is shaken, but when it is stopped and set down, all the ball bearings 1,2,3,4,5,6 always return to their original position with natural gravity.

If the mounting plane of the retainer 20 is parallel to the mounting plane of the housing 15 or the retainer axis 17 and the housing axis 13 are the same straight line, with gravity, the curved cone portion 21 of the retainer 16 will press the second layer ball bearings 4,5,6 at three contact points 22,23,24 in a position approximately 45 degrees to the center of the second layer ball bearings 4,5,6. The curved cone portion 21 transfers the horizontal and vertical forces to the center of the second layer ball bearings 4,5,6 better than the straight cone surface and will hold the retainer 16 at the housing axis 13 more stable than the straight cone surface. The radius of the curved cone portion 21 is slightly more than the radius of the bearing. If the retainer 16 is pressed on the mounting plane of the retainer 20, the second layer ball bearings 4,5,6 will easily move along the cylindrical wall portion 12. There is a pivot point of the retainer axis 17. Although the three contact points 22,23,24 between the curved cone portion 21 and the second layer bearings 4,5,6 change along the mounting plane of the retainer 20 and the mounting plane of the housing 15, the pressure at the three contact points 22,23,24 will always be equal and stable.

If the mounting plane of the retainer 20 is parallel to the mounting plane of the housing 15, the curved cone 21 will transmit the same force at the three contact points 22,23,24 to the center of the second layer ball bearings 4,5,6 and then split perpendicular to the cylindrical wall 12 and split to the center of the first layer ball bearings 1,2,3 through the two points of contact between each bearing. From the center of each ball bearing of the first layer ball bearings 1,2,3 the forces are separated into two directions. The first direction is the horizontal force perpendicular to the cylindrical wall 12, the second direction is the vertical force perpendicular to the flat base 11, the resultant force makes the first layer ball bearings 1,2,3 come into contact with the flat base 11 and the cylindrical wall 12 until stationed in equilibrium state. Due to the pivot point 25 as the pivot point of the central plane of the top ball bearings 14, the mounting plane of the housing 15 and the mounting plane of the retainer 20 are adjusted according to the deviation of the environmental surface plane. Although the central plane of the top ball bearings 14 changes from the horizontal around the pivot point 25, resulting in an angle of inclination 26 (shown in FIG. 6) up to approximately 18 degrees, the angle of inclination 26 can be limited to suit the operating environment. By setting a gap size 27 between the retainer 16 and the housing 10.

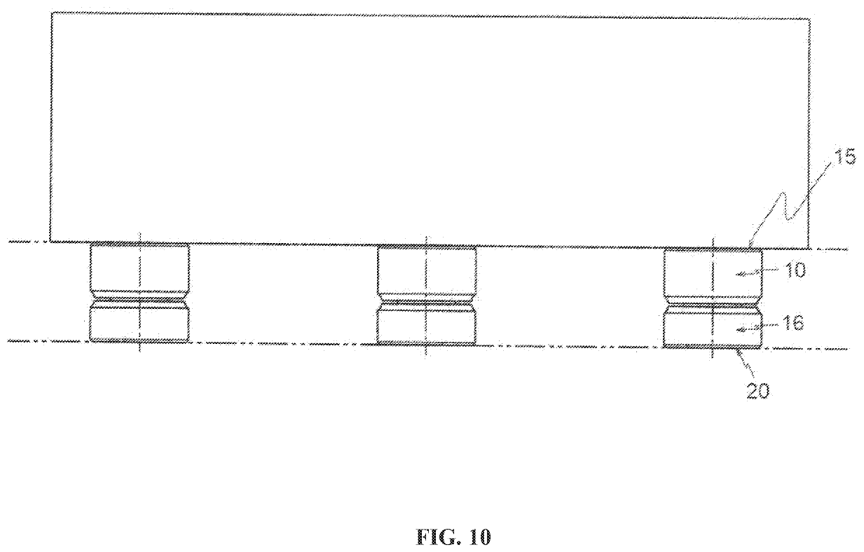

As shown in FIG. 10, the frontal view of one example of the implementation of the vibration damping device according to the invention. At least three units of this vibration damping device are placed under one electrical appliance using the mountain plane of the housing 15 attached to the bottom of the electrical appliance and the mounting plane of the retainer 20 attached to the floor for laying the invention. The pressure on each placing position should be distributed to have the same amount, consequently, the electrical appliances will be the most stable even the bottom surface of electrical appliances is a thin sheet of metal which could collapse with weight and the floor has a relatively high level deviation but the electrical appliance will be in truly stable contact with the vibration damping device.

If more than three units of this vibration damping device are used to support or attached to the underside of the electric appliance, this vibration damping device must have a threaded piece for levelling. All vibration damping device are therefore able to come in contact with the surface below the electrical appliances and to really feel close to the surface without any moving parts. All internal ball bearings are compressed from the housing 10 and the retainer 16, resulting in a very high increase in contact stress. This increase the vibration damping ratio of the vibration damping device to be at a very high level, making the frequency range least disturbed to the human hearing and making a sound electrical appliances to produce the sound with its fullest potential.

The above examples and disclosure are intended to be illustrative and not exhaustive. These examples and descriptions will suggest many variations and alternatives to this art. All these alternatives and variations are intended to be included within the scope of the attached claims. Those familiar with the art may recognize other equivalents to the specific embodiments described herein and the equivalents are also intended to be included in the attached hereto.

### BEST MODE FOR CARRYING OUT THE INVENTION

As mentioned above in the topic of full disclosure of the invention.

### INDUSTRIAL APPLICABILITY

The invention can be used as a vibration damping device for various objects or systems such as audio equipment (for example Turntable, CD player, DVD player, music file player, amplifier, speaker, etc.), equipment with motor (for example washing machines, air conditioners, etc.), object or systems that vibrate from the ground, etc.

What is claimed is:

1. A device for reducing vibrations of an object or a system comprising:
a housing comprising a first portion and second portion, the housing further comprising:
the first portion having a surface inside the housing which consists of two subsections,
a first subsection comprising a cylindrical wall, a second subsection forming a flat base which connects to the cylindrical wall, a radius of the cylindrical wall ranges from 2.25 to 2.4 times a radius of a ball bearing, a male lock located on a top edge of an outer wall of the housing, the first portion having a set of three ball bearings stacked in a plurality of layers by gravity on the flat base within the cylindrical wall of the housing, the three ball bearings of each layer having a gap between them, all the ball bearings can move along the surface inside the housing, the ball bearings have no diameter limitation, being spherical and approximately a same size;
the second portion comprising a retainer, the retainer comprising a curved cone inside the retainer, a radius of the curved cone having a size approximately 1.1 to 1.5 times the radius of the ball bearings; and, a contact point positioning approximately 45 degrees to the ball bearing center at a top layer for transferring a force from a top of an outer contact plane of the retainer, which can be angled along the outer contact plane deviation to a maximum angle of approximately 18 degrees;
the second portion comprising a female lock that rotates or compresses to lock the male lock of the first portion, wherein the female lock does not contact the male lock;
a gap formed between the second portion and the first portion of the housing preventing contact between each other;
the first portion, the second portion and the ball bearings can be made of at least one material selected from the group consisting of stainless steel, alloy steel, and other metal alloys, ceramics and advanced ceramics.

2. The device according to claim 1, wherein the flat base comprises one of a completely flat area of the base or only the contact point.

3. The device according to claim 1, wherein the plurality of layers, in a preferred embodiment having two layers of the ball bearings stacked, but not the only way it can be done.

4. A method of reducing vibrations of an object or a system using the device of claim 1, comprising: providing a contact stress between adjacent sets of the three ball bearings stacked in a plurality of layers.
